(19) United States
(12) Patent Application Publication
(10) Pub. No.: US 2007/0003691 A1
(43) Pub. Date: Jan. 4, 2007

(54) Color clustering technique for matching refinish paints

(76) Inventors: Allan Blase Joseph Rodrigues, Bloomfield Hills, MI (US); John Paul Gallagher, Hockessin, DE (US); David H. Alman, Royal Oak, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/418,433

(22) Filed: May 4, 2006

Related U.S. Application Data
(60) Provisional application No. 60/678,310, filed on May 5, 2005.

(51) Int. Cl. B05D 3/00; B05D 7/00

(52) U.S. Cl. 427/140; 427/421.1

(57) ABSTRACT

A process for refinishing or repainting a damaged paint area of a vehicle or part thereof using a computer-implemented method to determine a refinish paint formula that can be matched to the color of the original paint; in this process: a) the color data values of the original paint to be matched are determined; b) the color data values are entered into a computer containing a color cluster data base and color clusters each having a centroid and a refinish paint formula associated with each centroid; c) the color data values of the original paint are positioned in a color cluster via computer implementation and a refinish paint associated with the centroid of the color cluster having color characteristics close to the color characteristics of the original paint is obtained; and d) spray applying the refinish paint of step c) to the damaged paint area using conventional techniques thereby matching the color characteristics of the refinish paint to the undamaged original paint of the vehicle.

### CROSS-REFERENCE TO RELATED APPLICATION

This application claims the benefit of U.S. Provisional Application 60/678,310, filed May 5, 2005.

### BACKGROUND OF THE INVENTION

The present invention is directed to a method for matching the color of a refinish paint to the original paint color on repair or refinish of vehicles like, automobiles, trucks or parts thereof, more particularly, the invention is directed to a computer-implemented method for matching paint colors which utilizes color clustering and paint shading and blending techniques.

Vehicle paint color variability within the same original color can exist due to slight variations in the color of the paint formulations or application conditions used by the original equipment manufacturers (OEM). These variations may occur from one manufacturing location to another manufacturing location, or from one production run to another of a given color on the same vehicle model, or even during the course of a particular production run. Although these differences may be unnoticeable on separate vehicles, when they are present on adjacent body panels, such as a hood and a fender, of the same vehicle, the differences can be visibly perceptible. These color variations make it difficult to attain an excellent color match in an autobody repair shop.

When a car body is repaired, the repair area usually must be repainted. The color of the repair must match that of the rest of the car such that the repair area is not distinguishable to an observer. The refinish paint available often does not provide a sufficiently close color match since, within a given color code, color generally varies from one car to the next, or even from one part of a car to another. The finisher must then adjust the color of the paint by adding small amounts of colored tints, which in many instances requires the finisher to make several iterations to form a paint having an acceptable color match.

A number of methods have been devised to automate the process of paint matching. A typical method uses a device (e.g., a spectrophotometer) that measures color characteristics of the painted surface and matches the measurements to those archived in a computer database associated with previously developed paint formulas. In this method, the computer database is located at the repair facility. A paint formula having the color characteristics that are closest to those of the painted surface of the vehicle being refinished or repainted is chosen and used to formulate a paint, which is then applied to a test panel and compared to the paint on the vehicle that is being refinished or repainted. Typically, this formulated paint does not adequately match the color of the vehicle being refinished or repainted and must be manually adjusted until a color match is obtained. This is rather inefficient process and significantly affects labor cost of a finishing procedure.

A related method is shown in U.S. Pat. No. 6,522,977, which uses the VIN (Vehicle Identification Number) that contains a serial number that can be associated with the color used on the vehicle and provides that serial number to a central computer, which provides a recommended paint formula that can be used to formulate a paint to refinish or repair the damaged paint on the vehicle. There are provisions in the method that allow for modification of the paint formula to obtain a color match.

Another traditional approach has been to provide color chips of all colors and alternates to these colors that are available. A color chip is simply a color coated panel, which represents an available paint or color formulation. The finisher may then select a target color range, and select a best matched paint formulation from a library of color chips. Unfortunately, this approach is very expensive for the paint supplier since customers do not expect to pay for the color chips. Also, due to variations in the color chip preparation process, color chips sometimes differ in color properties from the actual target color sprayed by the user.

Yet another approach is a spectrophotometer based color matching system (e.g., DuPont ChromaVision®). This system measures the color of the paint being matched and calculates a formula to provide a color match. These aforementioned systems, however, do not provide an accurate visual display of the color match. Addition of a color cluster display would allow the formulator to have greater confidence in the color match. Also, as these systems are generally expensive, many users are not willing to pay such a high price.

Patent Application Publication U.S. 2002/0184171 A1 discusses a “System and Method for Organizing Color Values using an Artificial Intelligence Based Cluster Model”. It teaches the use of artificial intelligence methods, including neural networks and fuzzy logic but does not teach specific ways to implement color matching. It teaches the formulation associated with each color group but does not suggest matching the color of a vehicle being repainted to the formula corresponding to the centroid of a color cluster.

Refinish paint suppliers often provide alternate formulas to allow matching all variations of a given car color. Each of these formulas may also be accompanied by a color chip for a visual check of the color. Typically, paint manufacturers collect car parts from a large number of cars and visually inspect them to determine where to position alternates. Visual judgments are subjective and tedious. If too many alternates are provided, it is confusing and difficult for the refinisher to choose the best alternate. If there are too few, they may not be adequate to allow matching of all cars. There is a need for an objective method to optimize the number of alternates and their color positions such that all cars in that color can be matched by the refinisher using one of the alternates and spray application blending skills.

There is a need for computer-implemented method that will assist the finisher in a repair facility to select an optimum color matched paint in refinishing or repainting of a vehicle or part thereof. This method must utilize instrumental multi-angle color measurements (standard CIE L*, a*, b* values) of the paint on the vehicle or vehicle parts to characterize the color variations of the original color of vehicles that occur, for example, from different manufacturing sites or from entry points into the country, like rail heads and docks. Such a method needs to utilize these measurements, preferably, using a computer system to obtain optimum paint formulas that when formulated into paints can be applied using standard application techniques to match the original color of a vehicle or part that is being repainted or refinished.

### SUMMARY OF THE INVENTION

The present invention is directed to a process for refinishing a damaged paint area of a vehicle or part thereof or repainting of the same using a computer-implemented method to determine a color matchable refinish paint formula that is used to form a refinish paint used for repair of the damaged paint area and match the color of the original paint; the process comprises:
a) determining the color data values of the original paint to be matched;
b) entering the color data values into a computer containing a color cluster data base and color clusters, wherein each color cluster has a centroid and a refinish paint formula associated with each centroid of the color cluster;
c) positioning the color data values of the original paint in a color cluster via computer implementation and identifying a refinish paint formula associated with the centroid of the color cluster having color characteristics close to the color characteristics of the original paint and obtain the refinish paint having such color characteristics; and
d) using the refinish paint of step c) and spray applying the refinish paint to the damaged paint area by an operator thereby matching the color characteristics of the refinish paint to the undamaged original paint of the vehicle using conventional spraying, blending and shading techniques and drying and curing the refinish paint.

### BRIEF DESCRIPTION OF DRAWINGS

FIG. 1 is a block diagram showing steps for forming color clusters and centroids for the color clusters.

FIG. 2 is block diagram showing steps for obtaining a color matching paint for a typical vehicle refinishing or repainting.

FIG. 3 shows a single cluster of the data of Example 1 for near specular angle (15°)—FIG. 3.1; face angle (45°)—FIG. 3.2 and flop angle (110°)—FIG. 3.3.

FIG. 4 shows two clusters of data of Example 1 for each angle near specular angle (15°)—FIG. 4.1; face angle (45°)—FIG. 4.2 and flop angle (110°)—FIG. 4.3.

FIG. 5 shows the centroids for the two clusters of the data of Example 1 for each angle near specular angle (15°)—FIG. 5.1; face angle (45°)—FIG. 5.2 and flop angle (110°)—FIG. 5.3.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. Also, the disclosure of these ranges is intended as a continuous range including every value between the minimum and maximum values.

All patents, patent applications and publications referred to herein are incorporated by reference in their entirety.

The invention is useful for matching paint and most particularly for matching paint on vehicles. “Vehicle” includes automobiles; light trucks; medium duty trucks; semi-trucks; tractors; motorcycles; trailers; ATVs (all terrain vehicles); pick-up trucks and includes automobile bodies, any and all items manufactured and painted by automobile sub-suppliers, frame rails, commercial trucks and truck bodies, including but not limited to beverage bodies, utility bodies, ready mix concrete delivery vehicle bodies, waste hauling vehicle bodies, and fire and emergency vehicle bodies, as well as any potential attachments or components to such truck bodies, buses, farm and construction equipment, truck caps and covers, commercial trailers, consumer trailers, recreational vehicles, including but not limited to, motor homes, campers, conversion vans, vans, pleasure vehicles, pleasure craft snow mobiles, all terrain vehicles, personal watercraft, motorcycles, boats, and aircraft. Also included are industrial and commercial new construction and maintenance thereof; cement and wood floors; walls of commercial and residential structures, such office buildings and homes; amusement park equipment; concrete surfaces, wood substrates, marine surfaces; outdoor structures, such as bridges, towers; coil coating; railroad cars; machinery; OEM tools; signage; fiberglass structures; sporting goods; and sporting equipment.

CIE L*, a*, b* color coordinate values are standard values read by conventional basic color measuring instruments, such as, a portable calorimeter as shown in U.S. Pat. No. 4,917,495 or a spectrophotometer from X Rite Incorporated, Grandeville, Mich., for example, an X Rite SP64 spectrophotometer.

“Color cluster” refers to a cluster of L*, a*, b* data values taken from measurements of a group of vehicles of the same paint color.

“Centroid” means the center of a color cluster from which a paint formula is calculated via computer implementation, which is matchable by conventional spraying, blending and shading techniques to an original paint color that is within the color cluster.

“Cluster Analysis” is the procedure used to form clusters and determine the size (diameter) of the cluster and the relationship of one cluster to another cluster. Cluster analysis is more fully described in an article “Cluster Analysis”, a tutorial, by N. Bratchell, Chemometrics and Intelligent Laboratory Systems 6 (1989), 105-125, which is hereby incorporated by reference. Another useful reference is “Clustering Methods and their uses in Computational Chemistry” by Geoff M. Down and John M. Barnard, Reviews In Computational Chemistry 18, (2002), 1-40, which also is hereby incorporated by reference.

“Gamut” is the range of colors that can be reproduced in a specific color space or on a specific device.

“Gamut Visualizer” is an instrument that reproduces L*, a*, b* color coordinate values visually on a screen and is utilized to show color clusters and is described in U.S. Patent Publication 2004/0100643 A1, published May 27, 2004, which is hereby incorporated by reference.

The color of the paint is described in L*, a* and b* values which are coordinates in visual uniform color space and are related to X, Y & Z tristimulus values by the following equations which have been specified by the International Committee of Illumination:

L* defines the lightness axis
L*=116(Y/Yₒ)1/3-16

a* defines the red green axis
a*=500[(X/Xₒ)1/3(Y/Yₒ)1/3]

b* defines the yellow blue axis
b*=200[(Y/Yₒ)1/3-(Z/Zₒ)1/3]
where
Xₒ, Yₒ and Zₒ are the tristimulus values of the perfect white for a given illuminant;
X, Y and Z are the tristimulus values for the color.

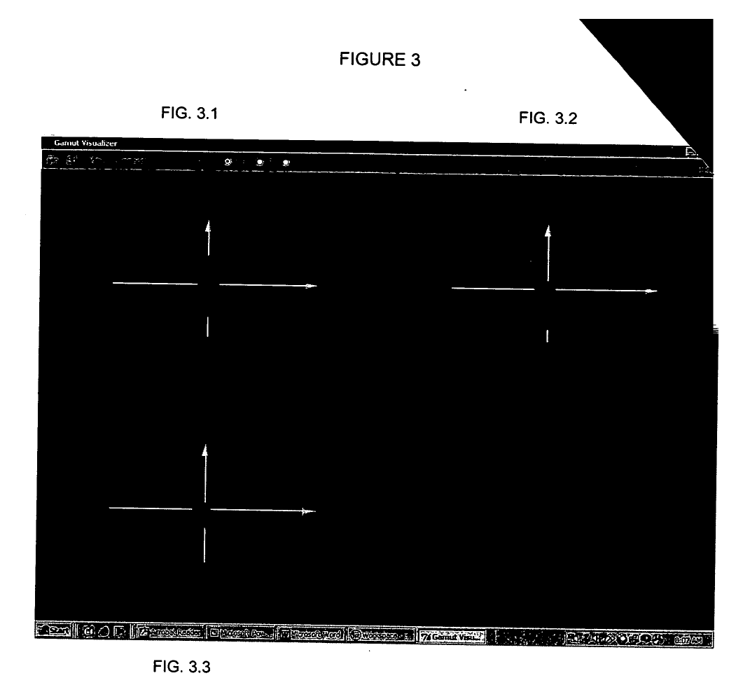

It is generally well accepted that the three-dimensional color space can be used to define colors in terms of certain color characteristics or color attributes. CIELAB, also commonly referred to as L*, a*, b* and Lab, is a uniform device that shows independent color space in which colors are located within a three-dimensional rectangular coordinate system. The three dimensions are lightness (L), redness/greenness (a) and yellowness/blueness (b). Referring to FIG. 3.1, the black/white axis which is L* in the figure represents a scale of luminous intensity or degree of lightness attribute and is shown as the vertical axis. The red/green axis which is a* represents a scale of red/green appearance is the axis perpendicular to the plane of the figure and the yellow/blue axis which is b* represents a scale of yellow/blue appearance is the horizontal axis. The configuration of each of the three axes is the same in each of the FIGS. 3-5 shown herein. The information contained in the combination of a color's a*-b* axes position represents the chromatic attributes known as hue and saturation. The hue varies with the position about the L* axis and the chroma changes with the distance from the L* axis.
Chroma=C*=\sqrt{a*²+b*²}
Hue=h=tan⁻¹(b*/a*);
this is referred to as the hue angle.

Therefore, a complete set or group of color attributes, or the attributes defining coordinates comprising lightness (L*), red/green (a*), and yellow/blue (b*) in the L*, a*, b* color space, fully defines a color point or locus in the color space. When generally used herein, the term “color” shall be understood to be fully defined by one or more complete sets or groups of color attributes or corresponding coordinates considering all three dimensions or axes in a three dimensional color space.

Color is usually judged versus a color standard, with color measurements expressed as a color difference versus that standard.
ΔL*=L*sample−L*standard
Δa*=a*sample−a*standard
Δb*=b*sample−b*standard
ΔC*=C*sample−C*standard

A total color difference is expressed as
ΔE*=\sqrt{ΔL*²+Δa*²+Δb*²}

The hue difference is expressed as a metric hue difference rather than a hue angle difference
ΔH*=k\sqrt{ΔE*₂−ΔL*²−ΔC*²}
or ΔH*=k\sqrt{2(C*ₛC*_{b}−a*ₛa*_{b}−b*ₛb*_{b})}
where, if a*ₛb*_{b >a*}_{b}b*ₛ [symbol] k=1; otherwise k=−1 subscripts s and b refer to standard and sample.

Transformations of CIELAB space have been published in order to make it agree better with visual assessments. The general equation is

$$Δ E = {[ {( \frac{Δ {L}^{*}}{{K}_{L} {S}_{L}} )}^{2} + {( \frac{Δ {C}_{ab}^{*}}{{K}_{C} {S}_{C}} )}^{2} + {( \frac{Δ {H}_{ab}^{*}}{{K}_{H} {S}_{H}} )}^{2} ]}^{0.5}$$

The CIE94 color space defines the parameters
S_{L}=1.0 for solid colors
S_{L}=0.034L*; If L*≦29.4., S_{L=}1.0 for gonioapparent colors
S_{C}=1+0.045C*_{ab}
where C*_{ab}=SQRT(C*_{standard}.C*ₛₐₘₚₗₑ)
S_{H}=1+0.015C*_{ab}

The parametric factors K_{L}:K_{C}:K_{H}=1:1:1 are generally satisfactory

Other commonly used color spaces are CMC and CIEDE2000

Color can be further described at a variety of refection angles, L(θ), a(θ) and b(θ), where θ is the particular reflection angle as measured from the specular direction. Commercial multi-angle calorimeters and spectrophotometers are widely available and are useful in measuring the L*, a* and b* values at several angles in one reading. Instruments often allow 5-10 angles of measurement, including multiple angles of illumination. Preferably, the following angles are used:15°, 45°, and 110° as measured from the specular angle when the color being matched contains metallic or pearlescent flakes. For solid colors, the 45° angle is sufficient, or even diffuse measurements, integrating the light reflected at all angles.

The aforementioned prior art methods for developing matching refinish paint formulations, e.g., using a spectrophotometer, color chips, alternate refinish color formulations, generally resulted in a large number of paint formulas that could be used and made it very difficult for a refinish operator to choose the closest color matching paint formula with any level of assurance that the paint could be colored matched. Often panel spray test runs were made and if a match could not be obtained, the formula was slightly adjusted or another formula chosen to provide a closer match. The process of this invention in general only provides several formulas optimized in color space to choose from and the process allows for making a choice of a paint formula that the refinish operator has a high level of assurance that the color of the resulting refinish paint will be color matchable to the original paint using standard application techniques.

This invention provides for a method for determining a color match of a refinish paint used to refinish a damaged painted vehicle substrate or repaint an entire vehicle or part, such as, an automotive fender, door panel or other part. Original paint color multi-angle data (CIE L*, a*, b* values) for the paint of undamaged vehicle, such as, an automobile or truck, is determined for 3 angles, preferably, 15°, 45° and 110°. Via computer implementation, the data is compared to and positioned in the color cluster resulting from data measured at the same angles on at least 30 vehicles for the particular paint color that is to be matched and a paint formula of a refinish paint for the centroid of that color cluster is identified and developed in a laboratory. The refinish paint is formulated according to the formula for the centroid. This refinish paint when spray applied by an operator skilled in the art, allows the operator to apply the refinish paint using standard spraying, blending and shading techniques to match the color of the undamaged original paint. For flake containing paints, visual comparison is usually required to determine that appearance of the flake, for example, color flop, flake sparkle and texture is acceptable. The applied refinish paint is subsequently dried and cured using standard techniques.

To implement the process of this invention, a color cluster data base must be developed for a specific color of a vehicle. Since there are variations in color even from the same manufacturing facility and from different manufacturing facilities, color data (L*, a*, b* values) must be obtained for at least thirty vehicles from different locations and vehicles made at different times. For vehicles manufactured overseas, measurements are taken at entry ports, rail-heads and similar locations where there are large groups of vehicles assembled.

In determining the volume of a color cluster, all of the data points within the cluster will be color matched by conventional blending techniques using the formula of the centroid of the cluster. The cluster is mapped in multi-dimensional color space that allows for the three dimensions of color and the multiple angles at which it is measured. The use of visually uniform color space, such as, CIE94 allows the three dimensions of color space to be weighted equally. It may be desirable to weight the measurement angles for customer preference in determining the volume of the color cluster for blendable color matching paint. The multiple angles of measurement are weighted to allow for customer preferences. For example, when approaching a vehicle and judging color acceptability of a paint repair, especially on a horizontal surface, the 110° angle is the most noticeable and should be weighted the highest. On the other hand, some customers place a greater emphasis in color match when viewed very close to the mirror or specular angle of reflection of the light source. In such a case, the 15° angle should be weighted higher.

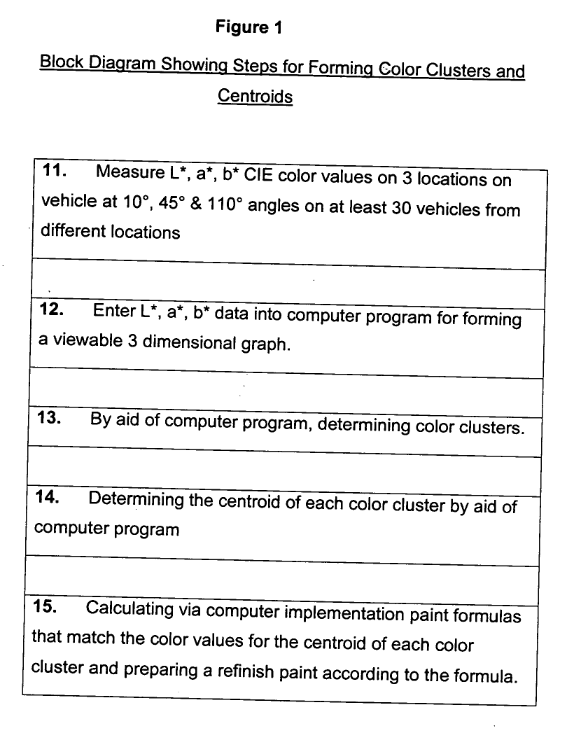

FIG. 1 is a block diagram showing a procedure for forming color clusters and centroids of the color clusters and for calculating the matching paint formulas for the centroids. Box 11, of FIG. 1 shows that for a given color, the L*, a*, b* CIE color values are measured on at least 30 vehicles, at least 2 different places on the vehicle, typically on a horizontal surface, such as, the roof or hood and on a vertical surface, such as, a side door or side panel and measured at three different angles, preferably, 15, 45 and 110 degrees using an color measuring instrument, such as, the aforementioned calorimeter or spectrophotometer.

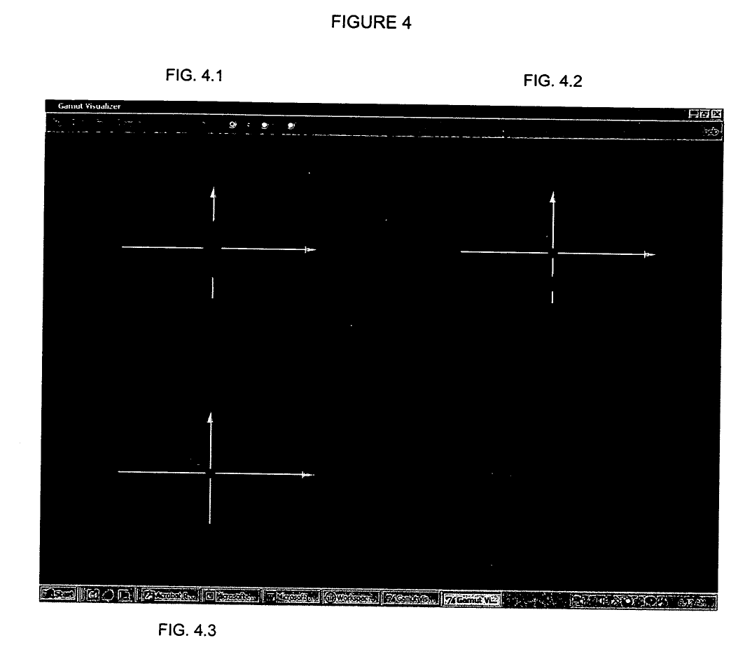

Box 12 of FIG. 1, shows that the L*, a*, b* values are entered into a computer and the program provides a three dimensional graph having L*, a*, b* co-ordinates as shown in FIG. 3.1. FIG. 3.1 shows a single cluster of L*, a*, b* values. Box 13 of FIG. 1 shows that by aid of a computer program, color clusters are determined. Typical color clusters are shown in FIG. 4.1-FIG. 4.3. Box 14 of FIG. 1 shows that the centroid of each color cluster is determined by aid of a computer program using Cluster Analysis techniques.

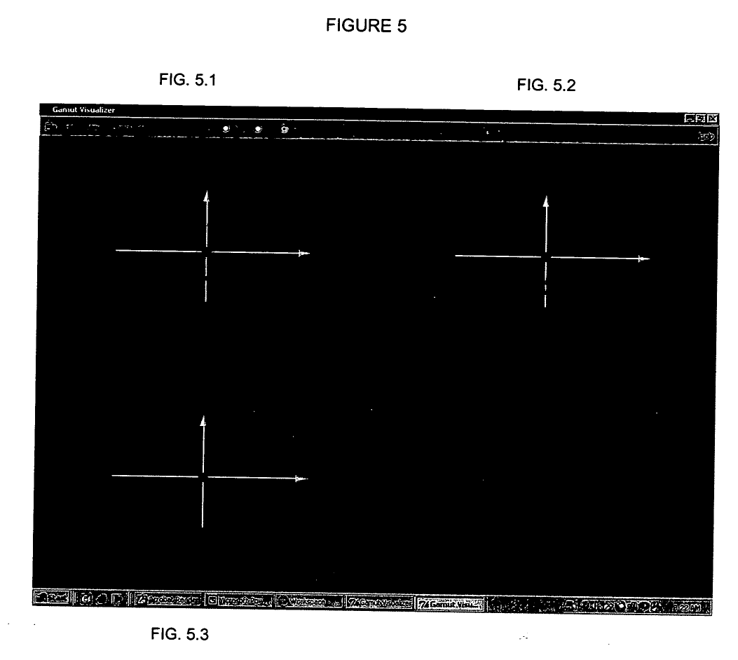

A Gamut Visualizer is used to display the data as shown in FIG. 3.1-3.3, FIG. 4.1-4.3 and FIG. 5.1-5.3.

The computer program utilizes Cluster Analysis techniques to determine the size of the color cluster, the number of clusters, the distance between clusters and the centroid of each cluster.

Cluster Analysis techniques are described in detail in an article “Cluster Analysis” by N. Bratchell, and “Clustering Methods and their uses in Computational Chemistry” by Geoff M. Down, and John M. Barnard, supra. From these articles, those skilled in the art can readily determine useful color clustering techniques used for determining color clusters, the size and diameter of color clusters, the distance between color clusters and the centroid of each color cluster.

Box 15 of FIG. 1 shows that a refinish paint formula is calculated that matches the L*, a*, b* color values of the centroid of each color cluster. A refinish paint having these color values is formulated in a laboratory by a skilled technician and is available to the person refinishing or repairing the vehicle.

When new car colors are introduced, refinish paint suppliers receive color standards. These standards can be matched through visual methods or commercial computer color matching programs, such as, Datamatch® (Datacolor, Lawrenceville, N.J.). The color difference between the color values of the centroid and this first match can then be adjusted using the same commercial software or methods such as disclosed in Armstrong et al, U.S. Pat. No. 3,690,771 issued Sep. 12, 1972 which is hereby incorporated by reference. Other commercially available color shading programs are available from GretagMacBeth LLC New Windsor, N.Y., USA.

The important point of the novel process of this invention is that if an original paint color falls within a color cluster, the paint formula directly derived from the centroid of the color cluster will be matchable to the original paint of the vehicle being refinished by a skilled technician using standard spraying, blending and shading techniques.

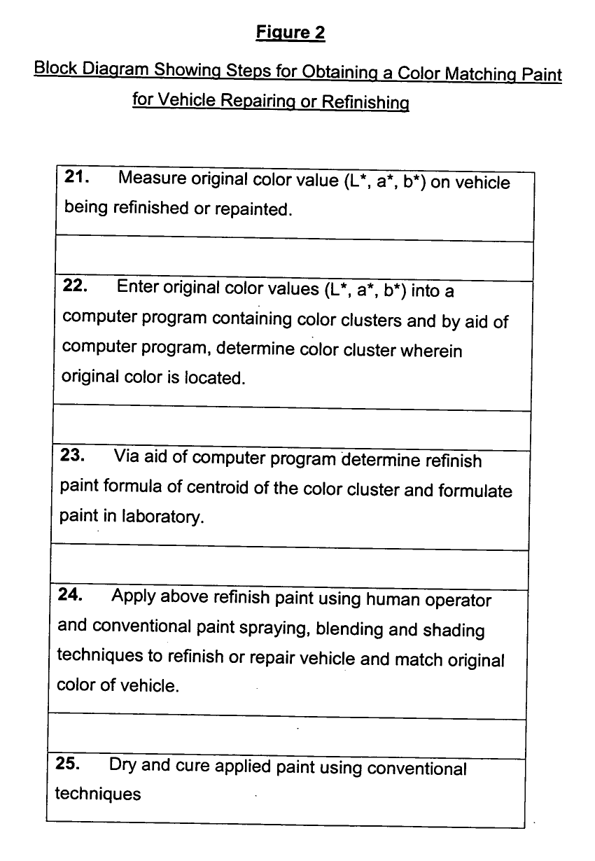

FIG. 2 shows the procedure for obtaining a color matching refinish paint for repairing or repainting a vehicle using the color cluster and related refinish paint formula for the centroid of the color cluster that has been developed. The L*, a*, b* values of the original paint on a vehicle that is to be refinished or repainted are measured by a technician (Box 21, FIG. 2). These values are entered into a computer equipped with a program that contains the paint formulas for the centroids of the color clusters that are related to the original color and the program determines the color cluster in which the original paint is located based on the L*, a*, b* values of the original paint (Box 22, FIG. 2). With the aid of the computer program, the paint formula for the centroid of this color cluster is determined and a paint formula is provided and the related refinish paint is identified (Box 23, FIG. 2). The refinish paint has been developed in a laboratory and is identified and provided to the technician who then applies it to the vehicle being repaired. The technician uses conventional paint spraying, blending and shading techniques spray applies the refinish paint to the vehicle matching the original color of the vehicle (Box 24, FIG. 2). The paint is then dried and cured using conventional techniques (Box. 25, FIG. 2).

The following other alternative methods can be used to match the color of the original finish of the vehicle being repainted or refinished:

Centroids are developed using the above procedures. Color chips for each of the refinish paints developed for each centroid are then prepared. A color chip comprises a substrate that is coated with the refinish paint and dried and cured. To match the original paint of the vehicle being prepared, the technician physically places the color chip on the original paint and chooses the closest color match and applies that paint using conventional spray application color matching techniques.

This is in contrast to current color matching procedures wherein a manufacturer provides a series of color chips that match alternate refinish paint formulas. The chips are positioned in close proximity to the original paint area to be refinished and the closest chip is chosen and the refinish paint that is represented by the chip is used for the repair. Such repair may or may not match the original color depending on the alternate refinish paint formulas that are available since the color positions of the chips are not optimized.

Another procedure that is currently used is that a paint supplier will provide chips only for a refinish paint that matches the original color of the OEM paint as manufactured and alternate descriptions of refinish paints available are provided. The refinisher places the chip representing the original paint as manufactured and judges the difference of the paint on the vehicle that is to be matched, e.g., lighter and greener at near-specular angle and darker at the flop angle, and matches that information to the description of alternate paint formulas that are available and chooses the closest alternate and then attempts to spray match the color of the vehicle being repaired. Such a technique may or may not provide an adequate color match depending on the judgment of the refinisher and the alternate paint formulas available.

Another technique according to this invention is to use a spectrophotometer based color matching system, e.g., DuPont ChromaVision®. A refinisher enters or measures the L*, a*, b* color values from the original paint into the aforementioned color matching system and a matching available refinish paint is provided for the centroid wherein the color values of the original paint fall and the technician applies the paint using conventional spray color matching techniques.

In a current procedure that uses a spectrophotometer, the color of the vehicle to be refinished is measured and a search is conducted either manually or via computer to find the closest alternate paint formula to match the color of the vehicle. It is possible to weight the color difference measurements at each angle differently to agree with predetermined customer preferences in determining the closest matching alternate paint formula. Depending on the alternate paint formulas available an acceptable color match may or may not be achieved since the color position is not optimized.

The novel process of this invention can be used to match finishes on vehicles having a standard pigmented mono coats, clear coat/pigmented base coat or tri-coat finishes and can be used to match solid color as well as coatings containing metallic flake and or special effect imparting pigments.

The present invention is further defined in the following Example. It should be understood that this Examples is provided by way of illustration only. From the above discussion and these Examples, one skilled in the art can ascertain the essential characteristics of this invention, and without departing from the spirit and scope thereof, can make various changes and modifications of the invention to adapt it to various uses and conditions. As a result, the present invention is not limited by the illustrative example set forth herein below, but rather is defined by the claims contained herein below

The following Example illustrates the invention.

### EXAMPLE

L*, a*, b* color data values were determined for 142 vehicles coated with dark metallic blue paint 123 from DuPont (E.I. DUPONT DE NEMOURS AND COMPANY, Wilmington, Del.) L*, a*, b* color data values were measured using an X-Rite MA 90B Metallic Field Colorimeter made by X-Rite Incorporated, Grandville, Mich. Color data values were taken on the hood and on the driver's side door of each vehicle. L*, a*, b* color data values were recorded at these two locations on the vehicle at 15°, 45° and 110° viewing angles. Typical L*, a*, b* color data values ranged, for example, on the hood taken at the 15° angle, from L* 87.87, a* −4.45, b* -24.32 to L* 105.06, a* −1.88, b* −22.27.

### Comparative Example

All of the color data values were entered into a Gamut Visualizer and a single color cluster was determined for each of the viewing angles. This is shown in FIGS. 3.1, 3.2 and 3.3, respectively, a single color cluster at 15°, 45° and 110° is shown in these figures. A centroid was determined for each of the respective color clusters (15°, 45° and 110°). The L*, a*, b* color values of the centroids at each of the above angles is as follows:

| | | | | | | |
|---|---|---|---|---|---|---|
| FIG. 3.1 (15°) | L* | 97.51 | a* | −3.12 | b* | −22.93 |
| FIG. 3.2 (45°) | L* | 49.09 | a* | −0.76 | b* | −17.37 |
| FIG. 3.3 (110°) | L* | 21.36 | a* | 1.69. | b* | −16.07 |

A refinish paint formula was developed that matched the L*, a*, b* color values of the above centroids.

An attempt was made to match the paint of a vehicle located at the outer periphery of the color cluster. The vehicle had the following original paint color values: 15° angle L* 87.87, a* −4.45, b* −24.32, at 45° angle, L* 50.11, a* −1.84, b* −19.2 and 110° angle, L* 23.57, a* 1.71, b* −18.10. The refinish paint formulated to match the L*, a*, b* values of the centroid for the color cluster was applied using standard application color shading techniques but the original color could not be matched.

The Invention

All of the color values L*, a*, b* color values determined above for each of the angles 15°, 45° and 110° were evaluated using cluster analysis techniques described in “Cluster Analysis”and “Clustering Methods and their uses in Computational Chemistry” by Geoff M. Down, and John M. Barnard, supra, whereby a color cluster diameter and distance between color clusters was set and a centroid was determined for each color cluster. FIG. 4.1-4.3 show two color clusters for each of the angles, 15°, 45° and 110° as displayed on a Gamut Visualizer. A centroid was determined for each of the color clusters and is shown if FIG. 5.1-5.3. The centroids are as follows:

| | | | | | | | |
|---|---|---|---|---|---|---|---|
| FIG. 5.1 (15°) | Red Cluster | L* | 101.41 | a* | −2.48 | b* | −22.53 |
| | Green Cluster | L* | 90.45 | a* | −4.30 | b* | −23.62 |
| FIG. 5.2 (45°) | Red Cluster | L* | 42.81 | a* | −0.17 | b* | −16.28 |
| | Green Cluster | L* | 51.92 | a* | −1.84 | b* | −19.26 |
| FIG. 5.3 (110°) | Red Cluster | L* | 19.49 | a* | 1.77 | b* | −14.77 |
| | Green Cluster | L* | 24.63 | a* | 1.54 | b* | −18.32 |

A refinish paint formula was developed for each of the clusters using computer implemented techniques well known to those skilled in the art to match the L*, a*, b* values of each of the above centroids. The computer implemented program determined that the original paint L*, a*, b* values measured above are closer to the Green Cluster and a refinish paint was formulated for the centroid of the Green Cluster for use in refinishing the vehicle. The refinish paint was spray applied to the vehicle by using conventional color spraying and color matching techniques a matching paint repair was made that was not noticeable to an observer.

What is claimed is:

1. A process for refinishing a damaged paint area of a vehicle or part thereof using a computer-implemented method to determine a color matchable refinish paint formula used to form a refinish paint being used to repair the damaged paint area and match the color of the original paint; said process comprising:
a) determining the color data values of the original paint to be matched;
b) entering the color data values into a computer containing a color cluster data base and color clusters, wherein each color cluster having a centroid and refinish paint formula associated with each centroid;
c) positioning the color data values of the original paint in a color cluster via computer implementation and identifying a refinish paint formula associated with the centroid of the color cluster having color characteristics close to the color characteristics of the original paint and obtaining a refinish paint with said color characteristics; and
d) using the refinish paint of step c) and spray applying the refinish paint to the damaged paint area by an operator thereby matching the color characteristics of the refinish paint to the undamaged original paint of the vehicle using conventional spraying, blending and shading techniques and drying and curing the refinish paint.

2. The process of claim 1, wherein the refinish paint is a repair basecoat for repairing a basecoat/clearcoat finish.

3. The process of claim 1 wherein the refinish paint is a pigmented repair mono coat for the repairing a pigmented mono coat finish.

4. The process of claim 1 wherein a three angle calorimeter or spectrophotometer is used to determine the color data characteristics of the original paint to be matched and wherein the color data comprise L*, a*, b* data values.

5. The process of claim 3 wherein the color cluster data base comprises L*, a* and b* values measured at three different angles wherein the three angles are identical to those angles used to measure the original paint color.

6. The process of claim 5 wherein the original paint contains solid color pigments, special effect pigments, metallic flake pigments or any mixtures thereof.

7. The process of claim 1 wherein the color cluster data base comprises L*, a*, b* color data values taken at least three different viewing angles for a specific color determined from at least three readings from different areas of the vehicle from at least thirty vehicles made by the same manufacturer at least at one vehicle manufacturing site.

8. The process of claim 1 wherein each of the values of the color cluster data base are plotted on video screen as a three dimensional layout.

9. The process of claim 1 or 7 wherein color clusters in the color cluster data base are determined via computer implementation using standard statistical techniques, a centroid is determined for each cluster and a refinish paint formula is determined via computer implementation for the centroid of each color cluster.

10. The process of claim 8 wherein color clusters in the color cluster data base are determined via computer implementation using standard statistical techniques, a centroid is determined for each cluster and a refinish paint formula is determined via computer implementation for the centroid of each color cluster.

11. The process of claim 8 wherein a color gamut visualizer is used to view color clusters and centroids for each color cluster.

12. A process for refinishing a damaged paint area of a vehicle or part thereof using a computer-implemented method to determine a color matchable refinish paint formula used to form a refinish paint being used to repair the damaged paint area and match the color of the original paint; said process comprising:
a) determining the color data values of the original paint to be matched;
b) entering the color data values into a computer containing a color cluster data base and color clusters, wherein each color cluster having a centroid and refinish paint formula associated with each centroid;
c) preparing color chips for each centroid using refinish paints prepared from the refinish paint formula of step b)
d) positioning the color chip for each on or adjacent to the original paint and visually determining the closest color match and
e) using the refinish paint associated with the color chip identified in step d) as the closest color match and spray applying the refinish paint to the damaged paint area by an operator thereby matching the color characteristics of the refinish paint to the undamaged original paint of the vehicle using conventional spraying, blending and shading techniques and drying and curing the refinish paint.
